(19) United States
(12) Patent Application Publication
(10) Pub. No.: US 2018/0236604 A1
(43) Pub. Date: Aug. 23, 2018

(54) METHOD OF FORMING AN ELONGATED BODY WITH AN EMBEDDED CHANNEL

(71) Applicant: AGENCY FOR SCIENCE, TECHNOLOGY AND RESEARCH, Singapore (SG)

(72) Inventors: Guijun BI, Singapore (SG); Jun WEI, Singapore (SG)

(73) Assignee: Agency for Science, Technology and Research, Singapore (SG)

(21) Appl. No.: 15/755,536

(22) PCT Filed: Aug. 11, 2016
(86) PCT No.: PCT/SG2016/050384

§ 371 Date: Feb. 26, 2018

(30) Foreign Application Priority Data
Aug. 26, 2015 (SG) 10201506744P

(51) Int. Cl. B23K 26/144; B23K 26/21; E21B 17/00

(52) U.S. Cl. CPC B23K 26/144; B33Y 10/00; E21B 17/003; B23K 26/21

(57) ABSTRACT

A method of forming an elongated body with an embedded channel extending longitudinally beneath a surface along a length of the elongated body, comprising forming the elongated body with an opened channel recessed into the elongated body; the opened channel having an inner and outer portion proximal and distal to and from a channel bottom respectively of the opened channel. The method further comprises placing an elongated cover over the opened channel, and having a base and two slope surfaces extending from the base toward an apex opposite the base to cover the inner portion of the opened channel with the base, and to form two grooves each having a profile defined by a corresponding slope surface of the elongated cover and a corresponding outer portion of the opened channel forming the groove. The method further comprises filling the two grooves to join the elongated cover to the elongated body.

### CROSS-REFERENCE TO RELATED APPLICATIONS

The present application claims the benefit of the Singapore patent application no. 10201506744P filed on 26 Aug. 2015, the entire contents of which are incorporated herein by reference for all purposes.

### TECHNICAL FIELD

Embodiments generally relate to a method of forming an elongated body with embedded channels or an embedded channel.

### BACKGROUND

Functional elongated components are very often embedded with high aspect ratio channels and cavities. However, due to the limitations of the conventional manufacturing processes, the fabrication of these high aspect ratio features is restricted and very costly. In oil & gas industry, downhole tools are examples of elongated components with extremely high aspect ratio holes of 700:1 (i.e. 5 m deep×7 mm in diameter), which are used in drilling wells. These downhole tools serve as safety, control, wire-lines and flow-line holes to allow for effective command, control and communications between the down-hole tools with the surface control crew. Cables for power supply & data communication, air-circuit logic flow, sensors and electronics for remote monitoring and control are contained inside these high aspect ratio holes.

Due to the harsh working environment of the downhole tools, which are subjected to high temperature, high pressure, corrosion and abrasion, the materials used for the downhole tools must have good mechanical properties, corrosion resistance and abrasion resistance to meet the requirements. Accordingly, nickel-base Inconel 718 material has been widely used for downhole tools. Inconel 718 is a gama double-prime (Ni₃N_{b}) precipitation-hardenable nickel-chromium alloy. This nickel-base material contains significant amounts of iron, niobium, and molybdenum, as well as smaller amounts of aluminium and titanium. The alloy possesses the superior properties such as high strength, good oxidation, corrosion and abrasion resistance.

Conventionally, deep gun-drilling is the most common technique to drill the high aspect ratio holes in the downhole tools. But this technique has some limitations with drilling nickel-base alloys, such as Inconel 718, to form the downhole tools.

For example, straightness control is an issue with the deep gun-drilling technique for Inconel 718 downhole tools. Gun-drilling of deep, thin-walled holes (typically of walls as fine as 5 mm) on Inconel 718 is challenging due to the tool edge radius effects. Such effects are activated by conservative drilling conditions for Inconel 718, which transforms the chip formation mode to a thrust-dominated mechanism. Critical changes in force generation are thus resulted, which affect the characteristics of drill deflection and thin wall deformation. As a consequence, the drill's self-piloting capability deteriorates—leading to uncontrollable deflection and hole misalignment.

Rapid degradation of the carbide gun drill tips is one of the most serious production issues with the deep gun-drilling technique. It is largely driven by continuous work hardening. An ever increase in cutting force and heat generation is thus resulted throughout the process. Coupled with the strong heat resistivity properties of Inconel 718 relative to its extremely low conductivity, gun drills degrade rapidly and fail under harsh thermal and mechanical loading conditions, despite the use of specially formulated drilling oil or coolant at high pressure.

Limited length and length-to-diameter ratio is another issue with the deep gun-drilling technique. The holes for the downhole tools are getting smaller and deeper. The machinery and tools used get pushed to a greater extreme. Conventionally, the length of the downhole tools and the length to diameter ratio are limited by the gun-drilling machine and tools available in the market. However, with the demand of the small holes getting longer and deeper, it has become increasingly difficult for deep gun-drilling technique to meet the demand.

Limited dimension and geometry of the small holes is a further issue with the deep gun-drilling technique. It is extremely difficult to drill holes with diameter smaller than 5 mm and aspect ratio higher than 700:1. Further, the geometry of the hole is only limited to the circular shape. Any other geometry is not feasible using gun-drilling process.

Poor surface roughness is also an issue with the deep gun-drilling technique. The surface of the holes is very rough after drilling. As the cables need to pull through the holes during assembling of the downhole tools, the rough surface may cause damages to the insulation layer of the cables. As a results, post processing of the hole surface to improve the surface quality is necessary with the deep gun-drilling technique.

Lengthy drilling process and high scrap rate are other issues associated with the deep gun-drilling technique. High strength and hardness of nickel-base alloy, such as Inconel 718, make wear of the carbides driller fast and the drilling process very slow. Frequent re-sharpening of the driller is necessary, which is associated with time-consuming realignment of the tools. Any misalignment and deflection will cause the scrap of the whole component.

Accordingly, example embodiments seek to provide a method of forming an elongated body with an embedded channel that addresses at least some of the issues identified above.

### SUMMARY

According to various embodiments, there is provided a method of forming an elongated body with embedded channels or an embedded channel extending longitudinally beneath a surface along a length of the elongated body. The method may include forming the elongated body with an opened channel recessed into the elongated body and with the opened channel extending longitudinally along the length of the elongated body, the opened channel having an inner portion proximal to a channel bottom of the opened channel and an outer portion distal from the channel bottom of the opened channel. The method may further include placing an elongated cover over the opened channel, the elongated cover having a base and two slope surfaces extending from the base toward an apex opposite the base wherein a distance apart between the two slope surfaces at the apex is smaller than a distance apart between the two slope surfaces at the base, to cover the inner portion of the opened channel with the base of the elongated cover to form the embedded channel, and to form two grooves, each groove having a profile defined by a corresponding slope surface of the elongated cover and defined by a corresponding outer portion of the opened channel. The method may further include filling the two grooves to join the elongated cover to the elongated body.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a schematic diagram of a method of forming an elongated body with an embedded channel extending longitudinally beneath a surface along a length of the elongated body according to various embodiments;

FIG. 2 shows a schematic diagram of a method of fabricating a long downhole tool with an embedded channel according to various embodiments;

FIG. 3A shows a front view and side view of an elongated body and an elongated cover for forming an elongated body with embedded channels according to various embodiments;

FIG. 3B shows a perspective view of the elongated body and the elongated cover of FIG. 3A according to various embodiments;

FIG. 4 shows photographs of mock samples of elongated body with embedded rectangular channels fabricated by the methods according to various embodiments.

FIG. 5 shows schematic diagrams illustrating a front view and a part cross-sectional side view of an elongated body with embedded hexagonal channels 560 which may be fabricated by the methods according to various embodiments; and

FIGS. 6A to 6F show schematic diagrams illustrating a method of forming an elongated body with an embedded channel extending longitudinally beneath a surface along a length of the elongated body according to various embodiments.

### DETAILED DESCRIPTION

Embodiments described below in context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

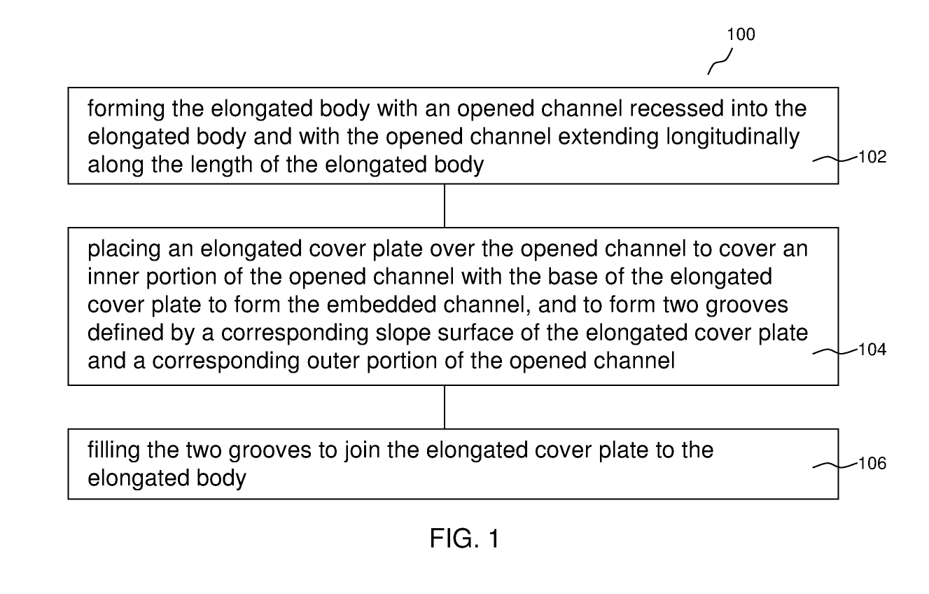

FIG. 1 shows a schematic diagram of a method 100 of forming an elongated body with an embedded channel extending longitudinally beneath a surface along a length of the elongated body. The method 100 may include, at 102, forming the elongated body with an opened channel recessed into the elongated body and with the opened channel extending longitudinally along the length of the elongated body. The opened channel may include an inner portion proximal to a channel bottom of the opened channel and an outer portion distal from the channel bottom of the opened channel. The method 100 may include, at 104, placing an elongated cover over the opened channel to cover the inner portion of the opened channel with a base of the elongated cover to form the embedded channel, and to form two grooves. The elongated cover may be in the form of a cover plate. The elongated cover may include the base and two slope surfaces extending from the base toward an apex opposite the base wherein a distance apart between the two slope surfaces at the apex is smaller than a distance apart between the two slope surfaces at the base. Each groove may include a profile defined by a corresponding slope surface of the elongated cover and defined by a corresponding outer portion of the opened channel. The method 100 may include, at 106, filling the two grooves to join the elongated cover to the elongated body.

In other words, according to various embodiments, the method may include shaping the elongated body to recess an opened channel into a surface of the elongated body such that the opened channel is orientated in a longitudinal direction along a length of the elongated body. The method may further include covering the opened channel with an elongated cover such that a bottom portion of the opened channel and a bottom surface of the elongated cover form an enclosed channel. At the same time, an upper portion of the opened channel may be separated by the elongated cover body to form two canals in a lengthwise direction along the surface of the elongated body. The method may also include sealing the two canals with fillers such that the elongated cover is joined to the elongated body.

According to various embodiments, filing the two grooves at 106 may further include filling the two grooves in a layer by layer manner.

According to various embodiments, the profile of each groove may include a V-shaped cross-sectional profile or any other shape feasible for the joining process.

According to various embodiments, the V-shaped cross-sectional profile may include an angle between a range of 30 degrees to 120 degrees, or 30 degrees to 90 degrees.

According to various embodiments, filing the two grooves at 106 may further include filling via laser aided additive manufacturing process.

According to various embodiments, forming the elongated body with the opened channel recessed into the surface at 102 may include a machining process. The machining process may include milling or planing.

According to various embodiments, the method 100 may further include forming the elongated cover before placing the elongated cover over the opened channel at 104. Accordingly, forming the elongated cover may include a machining process and the machining process may include milling or planing.

According to various embodiments, the inner portion of the opened channel may have a profile including substantially half of a desired profile of the embedded channel.

According to various embodiments, the elongated cover may include a recess in the base of the elongated cover. The recess may have a profile of other half of the desired profile of the embedded channel.

According to various embodiments, placing the elongated cover over the opened channel at 104 may include aligning the other half of the desired profile of the embedded channel in the elongated cover to the substantially half of the desired profile of the embedded channel in the opened channel to form the desired profile of the embedded channel.

According to various embodiments, placing the elongated cover over the opened channel at 104 may include clamping the elongated cover to the elongated body.

According to various embodiments, the opened channel may include a step portion at a transition from the outer portion of the opened channel to the inner portion of the opened channel. The step portion may include a shoulder.

According to various embodiments, the method 100 may further include surface finishing the completed elongated body having the embedded channel.

According to various embodiments, the laser aided additive manufacturing process may use powder feeding.

Various embodiments may provide an elongated body formed by the method as described herein. The elongated body may include an embedded channel extending longitudinally beneath a surface along a length of the elongated body.

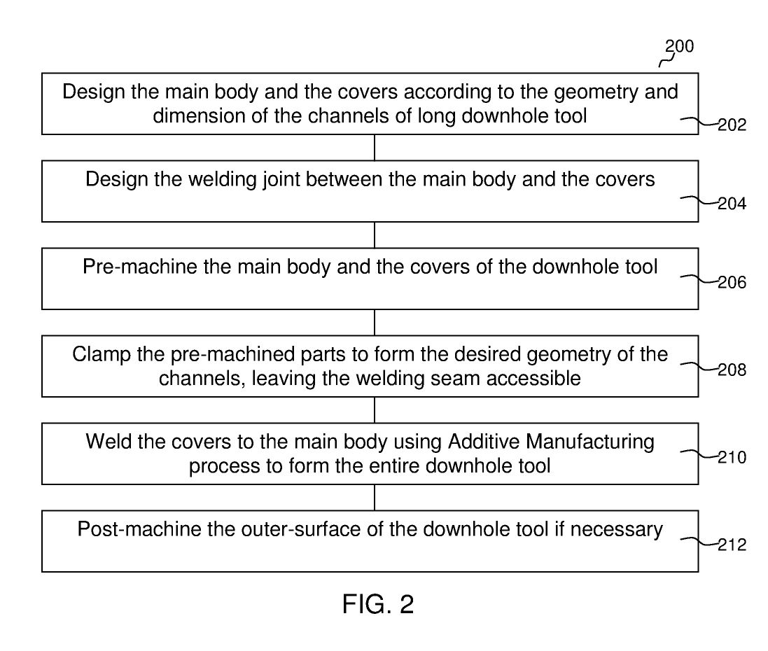

FIG. 2 shows a schematic diagram of a method 200 of fabricating a long downhole tool with an embedded channel according to various embodiments. The method 200 may address the limitations and problems with fabricating downhole tools using the deep gun-drilling technique.

As shown in FIG. 2, at 202, the main body of the downhole tool and the covers may be designed based on the geometry and the dimension of the desired channels of the downhole tool. At 204, the welding joints between the main body and the covers may be designed. At 206, the main body and the covers of the downhole tool may be pre-machined. At 208, the pre-machined main body and the covers may be clamped to form the desired geometry of the channels while leaving the welding seam accessible. At 210, the covers may be welded to the main body using Additive Manufacturing process to form the entire downhole tool. At 212, the outer-surface of the downhole tool may be post-machined.

Advantageously, methods according to various embodiments may allow new dimension and geometry of embedded channels to be formed. These embedded channels may be enabled to be formed by the machining plus additive manufacturing methods according to various embodiments. Accordingly, the dimension and geometry of the channels may be very diverse and may not be limited to only straight channels with circular shape cross-section. Channels with square cross-section, rectangular cross-section, hexagonal cross-section etc. may be formed according to the methods of the various embodiments.

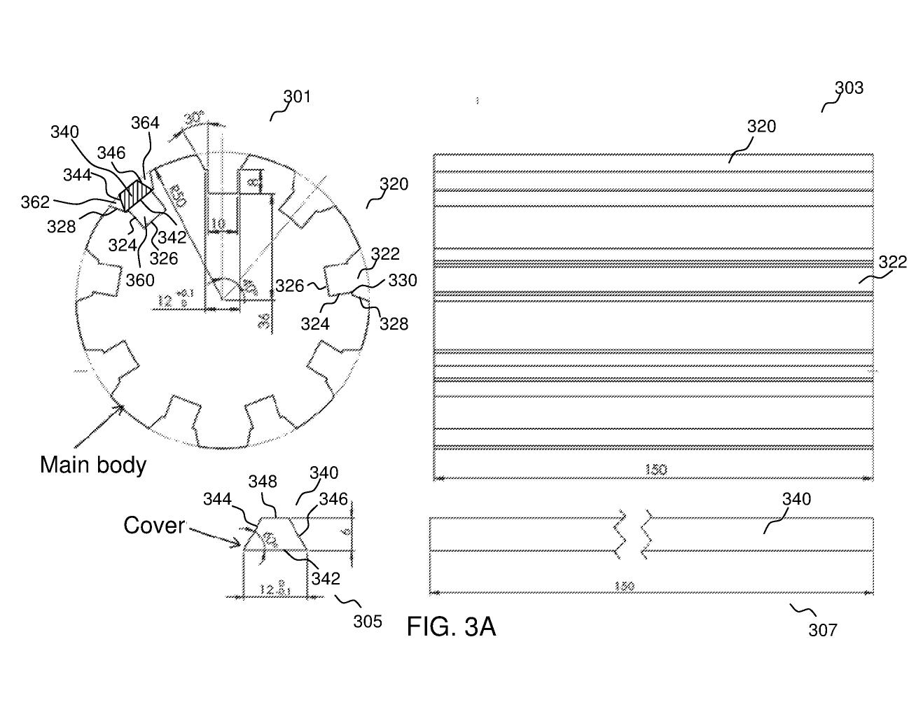

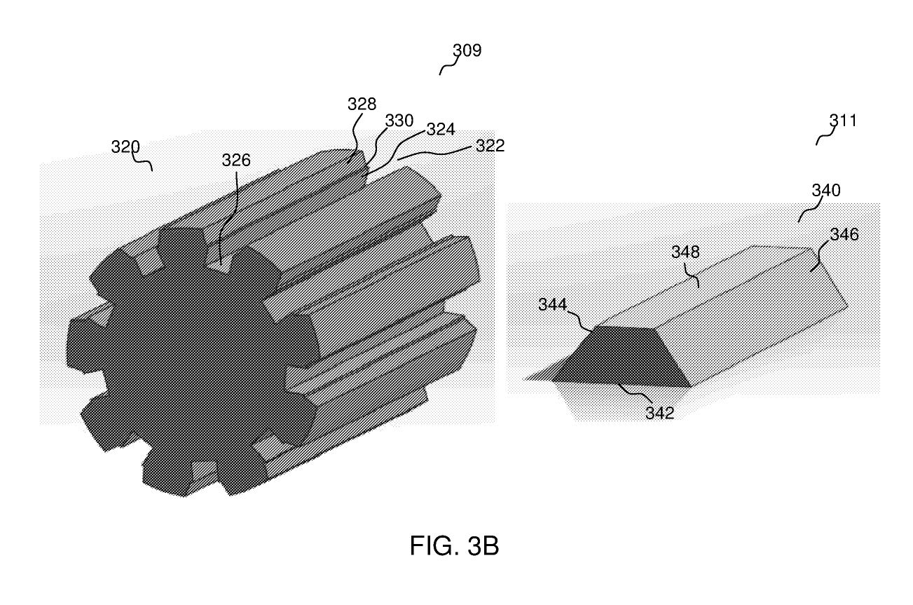

FIG. 3A shows a front view 301 and a side view 303 of an elongated body 320, and a front view 305 and a side view 307 of an elongated cover 340 for forming an elongated body with embedded channels, such as a downhole tool with channels, according to various embodiments. FIG. 3B shows a perspective view 309 of the elongated body 320 and a perspective view 311 of the elongated cover 340 according to various embodiments. As shown, the elongated body 320 may be formed with opened channels 322 recessed into the elongated body 320 and with the opened channel 322 extending longitudinally along the length of the elongated body 320.

According to various embodiments, the elongated body 320 with the recessed opened channel 322 may be formed via a machining process. The machining process may use subtractive methods and may include milling or planning.

Advantageously, as the channels 322 may be opened during machining, it may be very flexible to configure the channels 322 into various shapes, geometries and dimensions. For example, other shapes of the channels with curvature and inclined angles may be made possible. Furthermore, the straightness, dimensional accuracy and surface roughness may be much better controlled in various embodiments as compared to gun-drilling technique. Accordingly, the issues of straightness and rough surface may be addressed.

As shown in FIGS. 3A and 3B, the opened channel 322 may include an inner portion 324 proximal to a channel bottom 326 of the opened channel 322 and an outer portion 328 distal from the channel bottom 326 of the opened channel 322. The inner portion 324 of the opened channel 322 may have a desired cross-sectional profile. In FIGS. 3A and 3B, the inner portion 324 may have a rectangular cross-sectional profile. Further, the opened channel 322 may include a step portion 330 at a transition from the outer portion 328 of the opened channel 322 to the inner portion 324 of the opened channel 322. The step portion 330 may be in the form of a shoulder.

As shown in FIGS. 3A and 3B, the elongated cover 340 may be formed to include a base 342 and two slope surfaces 344, 346 extending from the base 342 toward an apex 348 opposite the base 342 wherein a distance apart between the two slope surfaces 344, 346 at the apex 348 is smaller than a distance apart between the two slope surfaces 344, 346 at the base 342. Accordingly, the elongated cover 340 may have a trapezoid cross-sectional profile. Further, similar to the elongated body 320, the elongated cover 340 may be formed via a machining process. The machining process may include milling or planning.

As shown in FIG. 3A, to form the embedded channels, the elongated cover 340 may be placed over the opened channel 322 of the elongated body 320 to cover the inner portion 324 of the opened channel 322 with the base 342 of the elongated cover 340. Accordingly, the elongated cover 340 may be assembled to the elongated body 320 such that a space defined by the base 342 of the elongated cover 340 and the inner portion 324 of the opened channel 322 may form the embedded channels 360. In FIG. 3A, the embedded channels 360 formed may have a rectangular cross-sectional profile. According to various embodiments, placing the elongated cover 340 over the opened channel 322 of the elongated body 320 may include clamping the elongated cover 340 to the elongated body 320.

With the elongated cover 340 placed over the opened channel 322, two grooves 362, 364 may be formed. A first groove 362 may have a profile defined by the first slope surface 344 and a corresponding outer portion 328 of the opened channel 320. A second groove 364 may have a profile defined by the second slope surface 346 and a corresponding outer portion 328 of the opened channel 320. The profile of each groove 362, 364 may include a V-shaped cross-sectional profile as shown or any other shape suitable for joining process. The V-shaped cross-sectional profile may include an angle between a range of 30 degrees to 120 degrees, or 30 degrees to 90 degrees.

The elongated cover 340 may then be joined to the elongated body 320 by filling the two grooves 362, 364. According to various embodiments, filing the two grooves 362, 364 may include filing the two grooves 362, 364 in a layer by layer manner. Further, filing of the two grooves 362, 364 may include filing via laser aided additive manufacturing process. The laser aided additive manufacturing process may use powder feeding.

According to various embodiments, the two grooves 362, 364 may function as weld seams such that the elongated cover 340 may be welded to the elongated body 320. Advantageously, with the two grooves 362, 364 formed along the surface of the elongated body 320, the two grooves 362, 364 may be accessible for the welding process. Further, V-shape weld seams may be preferable, as this geometry may increase the interaction area between the laser beam and the substrate. Additive manufacturing using powder or wire feeding or both may be suitable to fill the V-shape weld seams in a layer by layer manner, until the whole weld seams may be fully welded.

According to various embodiments, after the elongated cover 340 has been joined to the elongated body 320, the outer surface of the elongated body 320 may be surface finished to the desired dimension and surface roughness. The surface finishing may be via machining.

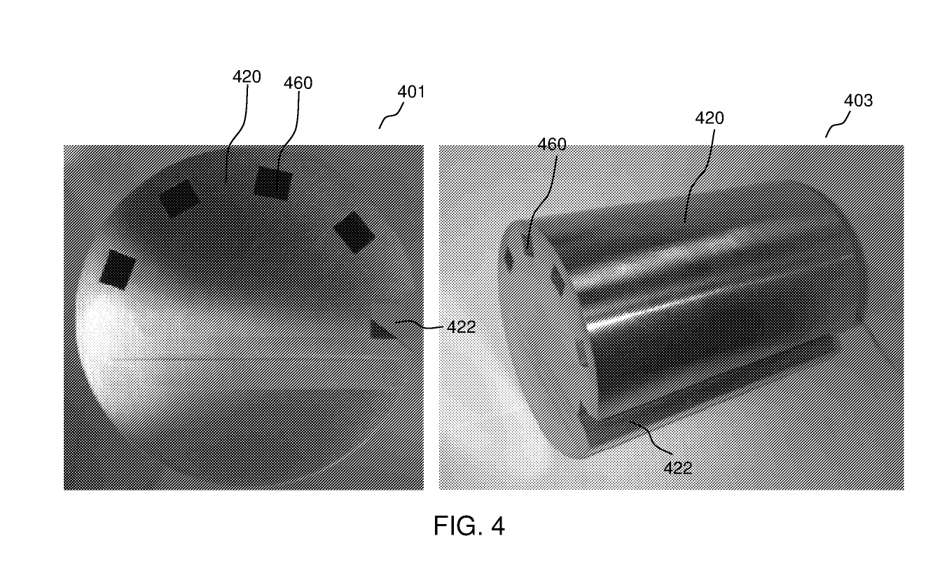

FIG. 4 shows photographs 401, 403 of mock samples of elongated body 420 with embedded channels 460 with rectangular cross-sectional profile and opened channels 422 fabricated by the methods according to various embodiments.

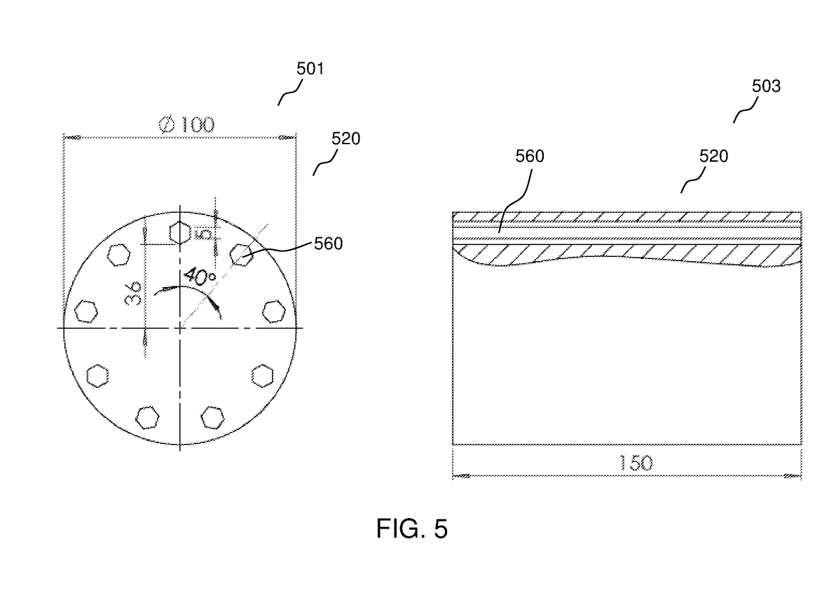

FIG. 5 shows schematic diagrams illustrating a front view 501 and a part cross-sectional side view 503 of an elongated body 520 with embedded channels 560 with hexagonal cross-sectional profile which may be fabricated by the methods according to various embodiments.

Methods according to various embodiments in which machining and additive manufacturing are combined have provided breakthrough in the area of fabricating small hole size and high aspect ratio for elongated body, such as downhole tools. Furthermore, various methods may allow embedded channels to be as near as possible to the outer surface of the elongated body, which is very challenging to be achieved with gun-drilling process.

Methods according to various embodiments may also significantly improve the productivity by drastically shortening machining time, quick change of machine tools and reduced setup and re-alignment time. More importantly, the scrap rate may be tremendously reduced. Further, re-working of parts may be feasible with methods according to various embodiments.

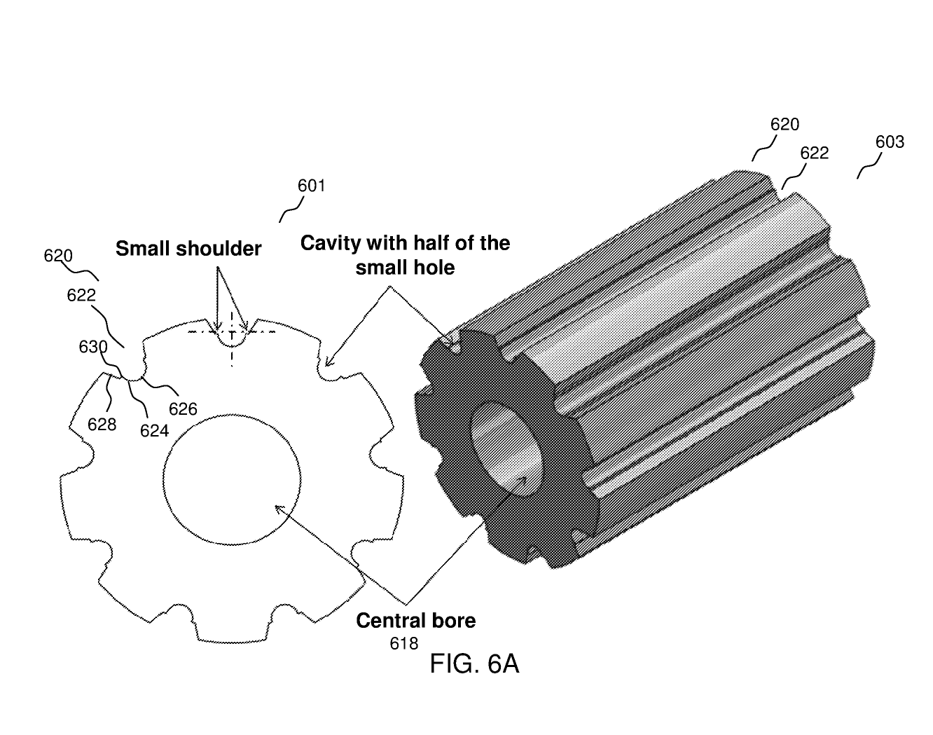

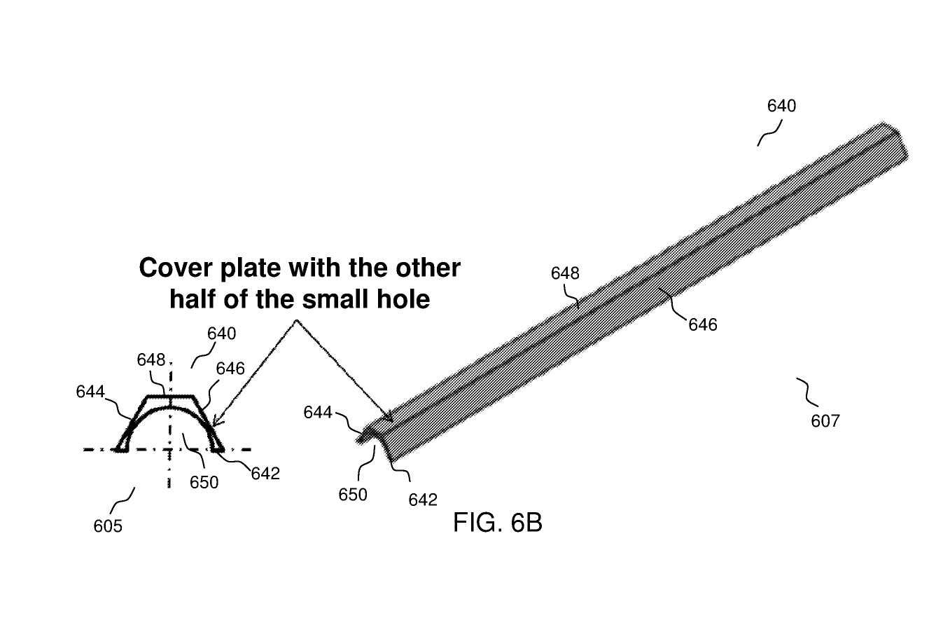

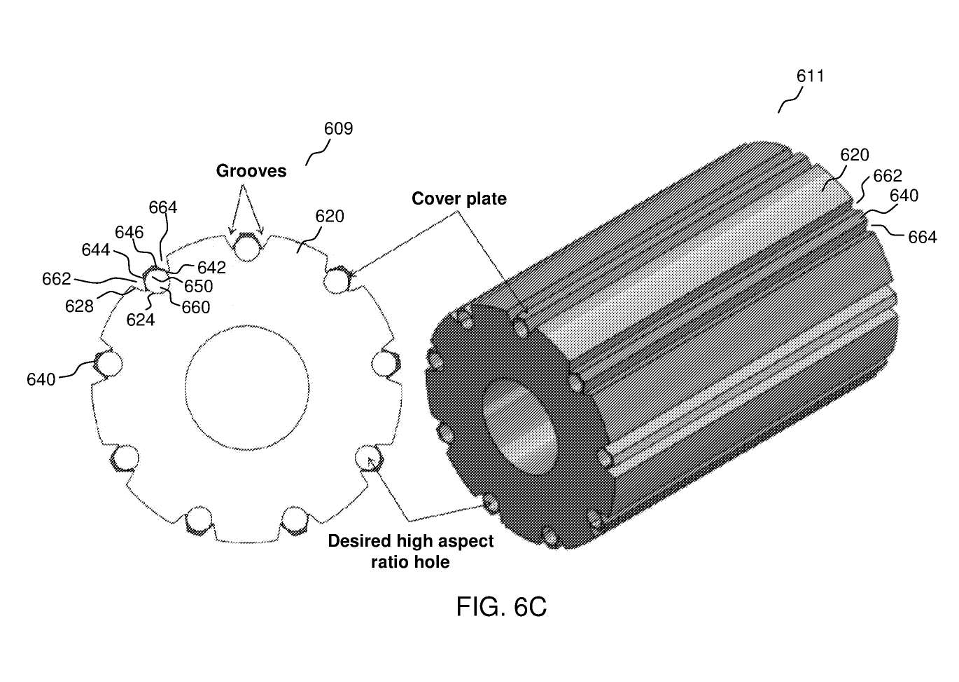

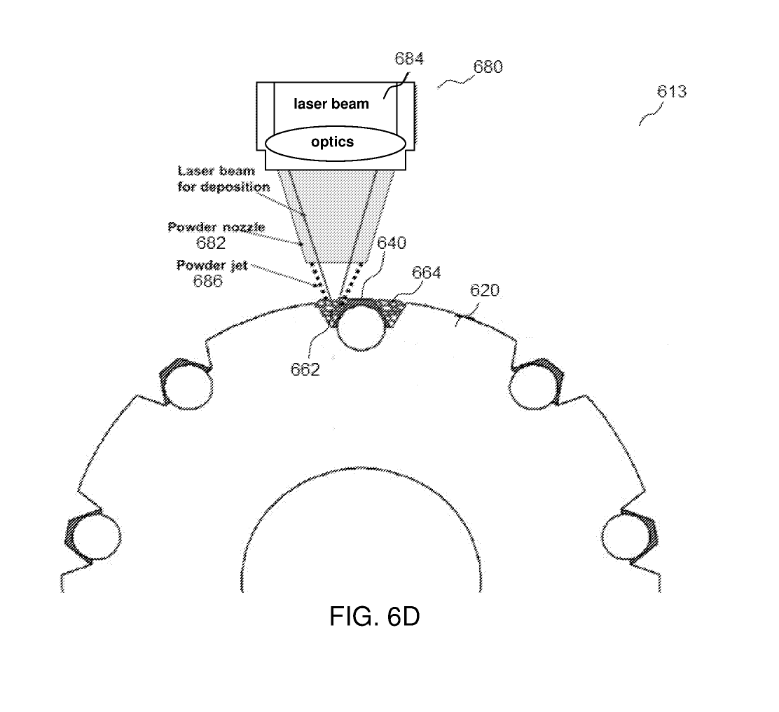

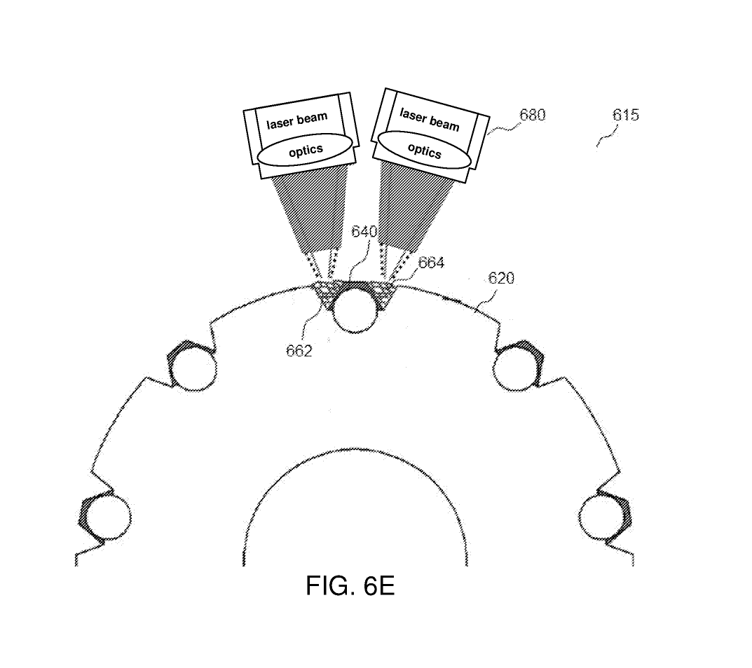

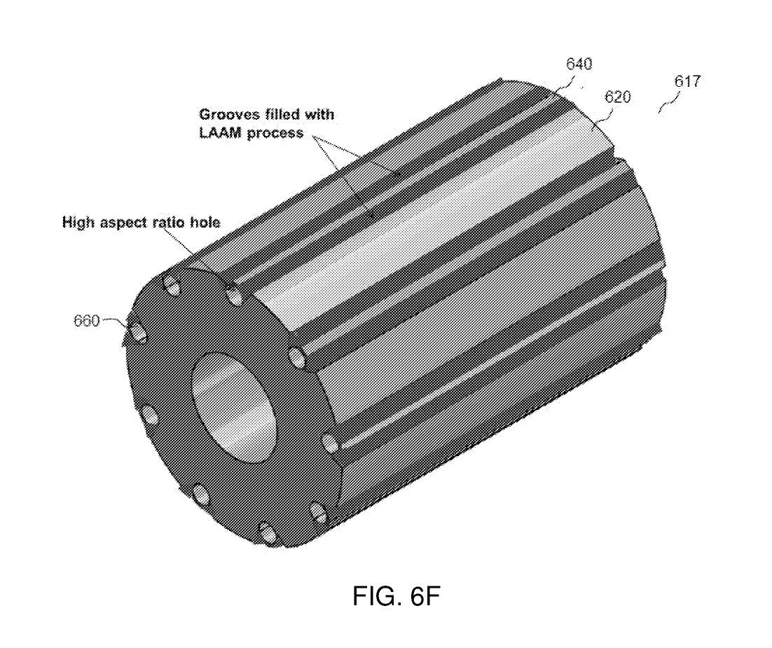

FIGS. 6A to 6F show schematic diagrams illustrating a method of forming an elongated body with an embedded channel extending longitudinally beneath a surface along a length of the elongated body according to various embodiments.

FIG. 6A shows a front view 601 and a perspective view 603 of an elongated body 620 according to various embodiments. In FIG. 6A, the elongated body 620 may be formed with an opened channel 622 recessed into the elongated body 620 and with the opened channel 622 extending longitudinally along the length of the elongated body. As shown, the opened channel 622 may include an inner portion 624 proximal to a channel bottom 626 of the opened channel 622 and an outer portion 628 distal from the channel bottom 626 of the opened channel 622. In FIG. 6A, the inner portion 624 may have a semi-circular cross-sectional profile. Further, the opened channel 622 may include a step portion 630 at a transition from the outer portion 628 of the opened channel 622 to the inner portion 624 of the opened channel 622. The step portion 630 may be in the form of a shoulder. According to various embodiments, the step portion 630 in the form of a shoulder at the edge of the semi-circular profiled inner portion 624 as shown in FIG. 6A may have a dimension of 0.5 mm to 1 mm.

According to various embodiments, the elongated body 620 with the recessed opened channel 622 may be formed via a machining process. The machining process may use subtractive methods and may include milling or planning. For example, the elongated body 620 may be machined to include a central bore 618. The opened channel 622 of the elongated body 620 may be machined as cavity including a cross-sectional profile which may be half of a desired cross-sectional profile of the desired embedded channel or small hole beneath the surface of a completed elongated body. Accordingly, the inner portion 624 of the opened channel 622 may have a profile including substantially half of a desired profile of the embedded channel.

FIG. 6B shows a front view 605 and a perspective view 607 of an elongated cover 640 according to various embodiments. In FIG. 6B, the elongated cover 640 may be formed to include a base 642 and two slope surfaces 644, 646 extending from the base 642 toward an apex 648 opposite the base 642 wherein a distance apart between the two slope surfaces 644, 646 at the apex 648 is smaller than a distance apart between the two slope surfaces 644, 646 at the base 642. As shown in FIG. 6B, the elongated cover 640 may further include a recess 650 in the base of the elongated cover 640. The recess 650 may have a cross-sectional profile which may be the other half of the desired cross-sectional profile of the desired embedded channel or small hole beneath the surface of the completed elongated body. Accordingly, the recess 650 may have a profile of other half of the desired profile of the embedded channel. According to various embodiments, the elongated cover 640 may be machined to include the slopping surfaces 644, 646 and the other half of the embedded channel or small hole.

According to various embodiments, the elongated cover 640 may be formed via a machining process. The machining process may include milling or planning.

FIG. 6C shows a front view 609 and a perspective view 611 of the elongated body 620 assembled with the elongated cover 640. To assemble the elongated body 620 and the elongated cover 640, the elongated cover 640 may be placed over the opened channel 622 of the elongated body 620 to cover the inner portion 624 of the opened channel 622 with the base 642 of the elongated cover 640. As shown in FIG. 6C, when the elongated cover 640 is assembled to the elongated body 620, a space defined by the base 642 of the elongated cover 640 and the inner portion 624 of the opened channel 622 may form the embedded channels 660. In FIG. 6C, the inner portion 624 of the opened channel 622 may have a profile including substantially half of the desired profile of the embedded channel 660 while the base 642 of the elongated cover 640 may include a recess 650 having a profile of other half of the desired profile of the embedded channel 660. Accordingly, placing the elongated cover 640 over the opened channel 622 may include aligning the other half of the desired profile of the embedded channel 660 in the elongated cover 640 to the substantially half of the desired profile of the embedded channel 660 in the opened channel 622 to form the desired profile of the embedded channel 660. According to various embodiments, placing the elongated cover 640 over the opened channel 622 of the elongated body 620 may include clamping the elongated cover 640 to the elongated body 620.

With the elongated cover 640 placed over the opened channel 622, two grooves 662, 664 may be formed. A first groove 662 may have a profile defined by the first slope surface 644 of the elongated cover 640 and a corresponding outer portion 628 of the opened channel 620. A second groove 664 may have a profile defined by the second slope surface 646 of the elongated cover 640 and a corresponding outer portion 628 of the opened channel 620. Accordingly, when the elongated cover 640 is assembled to the elongated body 620 to form the embedded channels 660 or the high aspect ratio holes, the upper portion 628 of the opened channel 622 may be separated by the elongated cover body to form two grooves 662, 664 in a lengthwise direction along the surface of the elongated body 620. Thus, the two grooves 662, 664 may be between the elongated cover 640 and the elongated body 620. The profile of each groove 662, 664 may include a V-shaped cross-sectional profile as shown or any other shape suitable for joining process. The V-shaped cross-sectional profile may include an angle between a range of 30 degrees to 120 degrees, or 30 degrees to 90 degrees, depending on the dimension of the components.

According to various embodiments, the elongated cover 640 may be joined to the elongated body 620 by filling the two grooves 662, 664. According to various embodiments, filing the two grooves 662, 664 may include filing the two grooves 662, 664 in a layer by layer manner. Further, filing of the two grooves 662, 664 may include filing via laser aided additive manufacturing (LAAM) process. The laser aided additive manufacturing process may use powder or wire feeding or both. Accordingly, the two grooves 662, 664 may be filled by laser aided additive manufacturing using powders to join the elongated cover 640 to the elongated body 620 in a layer by layer manner. According to various embodiments, the joining process may be done by either a single LAAM unit, or dual LAAM units to join the elongated cover 640 to the elongated body 620 in one single run.

FIG. 6D shows a schematic diagram 613 of joining the elongated cover 640 to the elongated body 620 using a single LAAM unit 680. FIG. 6E shows a schematic diagram 615 of joining the elongated cover 640 to the elongated body 620 using dual LAAM units 680. As shown, laser is adopted as a heat source to melt additive materials in the form of powder to fill up the grooves 662, 664. A powder nozzle 682 may be incorporated with a laser beam gun 684 such that a powder jet 686 from the powder nozzle 682 may provide powder into the grooves 662, 664 and the laser beam may melt the powder provided in the grooves 662, 664.

FIG. 6F shows a perspective view 617 of an elongated body 620 formed with embedded channels 660 extending longitudinally beneath a surface along a length of the elongated body by the methods according to various embodiments. After joining the elongated cover 640 to the elongated body 620, embedded channels 660 or high aspect ratio holes may be formed. By repeating the process to join multiple elongated covers 640 to the elongated body 620, a completed elongated body 620 with multiple embedded channels 660 or multiple high aspect ratio holes may be fabricated. According to various embodiments, depending on the required surface quality of the completed elongated body 620, post-machining of the completed elongated body 620 may be required. Accordingly, the completed elongated body 620 with embedded channels 660 may be surface finished to the required surface quality.

According to various embodiments, the geometry of the embedded channels 660 or the high aspect ratio holes may be in any shape depending on the requirements. The geometry of the cross-sectional profile may include circular, rectangular, triangular, tapered, etc.

Various embodiments have provided a method for manufacturing an elongated body, such as a downhole component, with small size subsurface channels for aspect ratio larger than 500. The channel size may be 1-10 mm in diameter for circular shape and similar size for other geometries. The channel may be as near to the component surface as possible. The elongated body may be fabricated using a hybrid method by combining subtractive machining and additive manufacturing technique.

According to various embodiments, the method may further include pre-machining the elongated body and the elongated cover.

According to various embodiments, the subtractive machining may be performed using at least one of milling and planning.

According to various embodiments, the method may include joining the elongated cover to the elongated body to form the completed elongated body, such as the downhole component, using an additive manufacturing technique using laser as heat source with powder feeding through a powder feeding nozzle integrated to the laser beam delivery system.

According to various embodiments, the method may include joining the elongated cover to the elongated body to form the completed elongated body, such as the downhole component, using an additive manufacturing technique using laser as heat source with wire feeding integrated to the laser beam delivery system.

Various embodiments have broken the barriers arising from the limitations from the current manufacturing techniques, e.g. gun-drilling technique, on the fabrication of embedded high aspect ratio channels and cavities. Various embodiments have shown that small size channels with high aspect ratio may be achievable. The channel size may be 1-10 mm in diameter for circular shape and similar size for other geometries. The aspect ratio may be higher than 500. The channel may be as near to the component surface as possible. The geometry of the channels may be of any shape, as long as it may be achievable by subtractive machining. Various embodiments may enable the flexible design and manufacturing of such kind of features in functional components, such as downhole tool, which may significantly improve the product quality, reduce the manufacturing time, reduce the scrap rate and save the cost. Methods according to various embodiments may be advantageous for fabricating embedded channels that are very near to the surface. This kind of channels may be difficult to be fabricated using traditional drilling method due to the high risk of deflection of the driller. However, with the hybrid manufacturing method according to various embodiments, this kind of channels may be easily fabricated because the welding depth may be shallow.

Methods according to various embodiments may be applied in the fabrication of embedded high aspect ratio channels and cavities for downhole tools in the oil and gas industry. The methods may also be extended for applications in marine, automotive and aerospace industries where similar requirements arise.

Various embodiments are defined by the following numbered Examples.

Example 1 is a method of forming an elongated body with an embedded channel extending longitudinally beneath a surface along a length of the elongated body, the method including: forming the elongated body with an opened channel recessed into the elongated body and extending longitudinally along the length of the elongated body, the opened channel having an inner portion proximal to a channel bottom of the opened channel and an outer portion distal from the channel bottom of the opened channel; placing an elongated cover plate over the opened channel, the elongated cover plate having a base and two slope surfaces extending from the base toward an apex opposite the base wherein a distance apart between the two slope surfaces at the apex is smaller than a distance apart between the two slope surfaces at the base, to cover the inner portion of the opened channel with the base of the elongated cover plate to form the embedded channel, and to form two grooves, each groove having a profile defined by each slope surface of the elongated cover plate and the corresponding outer portion of the opened channel adjacent to the respective slope surface; and filling the two grooves to join the elongated cover plate to the elongated body.

In Example 2, the method of Example 1 may further include that filling the two grooves comprises filling the two grooves in a layer by layer manner.

In Example 3, the method of Example 1 or 2 may further include that the profile of each groove comprises a V-shaped cross-sectional profile or any other shape suitable for joining process.

In Example 4, the method of Example 3 may further include that the V-shaped cross-sectional profile comprises an angle between a range of 30 degrees to 120 degrees, or 30 degrees to 90 degrees.

In Example 5, the method of any of Examples 1 to 4 may further include that filling the two grooves comprises filling via laser aided additive manufacturing process.

In Example 6, the method of any of Examples 1 to 5 may further include that forming the elongated body with the opened channel recessed into the surface comprises a machining process.

In Example 7, the method of Example 6 may further include that the machining process comprises milling or planing.

In Example 8, the method of any of Examples 1 to 7 may further include forming an elongated cover plate before placing the elongated cover plate over the opened channel.

In Example 9, the method of Example 8 may further include that forming the elongated cover plate comprises a machining process.

In Example 10, the method of Example 9 may further include that the machining process comprises milling or planing.

In Example 11, the method of any of Examples 1 to 10 may further include that the inner portion of the opened channel has a profile including substantially half of a desired profile of the embedded channel.

In Example 12, the method of Example 11 may further include that the elongated cover plate includes a recess in the base of the elongated cover plate, the recess having a profile of other half of the desired profile of the embedded channel.

In Example 13, the method of Example 12 may further include that placing the elongated cover plate over the opened channel comprises aligning the other half of the desired profile of the embedded channel in the elongated cover plate to the substantially half of the desired profile of the embedded channel in the opened channel to form the desired profile of the embedded channel.

In Example 14, the method of any of Examples 1 to 13 may further include that placing the elongated cover plate over the opened channel comprises clamping the elongated cover plate to the elongated body.

In Example 15, the method of any of Examples 1 to 14 may further include that the opened channel includes a step portion at a transition from the outer portion of the opened channel to the inner portion of the opened channel.

In Example 16, the method of Example 15 may further include that the step portion comprises a shoulder.

In Example 17, the method of any of Examples 1 to 16 may further include surface finishing the completed elongated body having the embedded channel.

In Example 18, the method of any of Examples 5 to 17 may further include that the laser aided additive manufacturing process uses powder feeding.

Example 19 is an elongated body formed by the method as defined in any of Examples 1 to 18.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of forming an elongated body with an embedded channel extending longitudinally beneath a surface along a length of the elongated body, the method comprising:
forming the elongated body with an opened channel recessed into the elongated body and with the opened channel extending longitudinally along the length of the elongated body, the opened channel having an inner portion proximal to a channel bottom of the opened channel and an outer portion distal from the channel bottom of the opened channel;
placing an elongated cover over the opened channel, the elongated cover having a base and two slope surfaces extending from the base toward an apex opposite the base wherein a distance apart between the two slope surfaces at the apex is smaller than a distance apart between the two slope surfaces at the base, to cover the inner portion of the opened channel with the base of the elongated cover to form the embedded channel, and to form two grooves, each groove having a profile defined by a corresponding slope surface of the elongated cover and defined by a corresponding outer portion of the opened channel; and
filling the two grooves to join the elongated cover to the elongated body.

2. The method of claim 1, wherein filling the two grooves comprises filling the two grooves in a layer by layer manner.

3. The method of claim 1, wherein the profile of each groove comprises a V-shaped cross-sectional profile.

4. The method of claim 3, wherein the V-shaped cross-sectional profile comprises an angle between a range of 30 degrees to 120 degrees.

5. The method of claim 1, wherein filling the two grooves comprises filling via laser aided additive manufacturing process.

6. The method of claim 1, wherein forming the elongated body with the opened channel recessed into the surface comprises a machining process.

7. The method of claim 6, wherein the machining process comprises milling or planing.

8. The method of claim 1, further comprising forming an elongated cover before placing the elongated cover over the opened channel.

9. The method of claim 8, wherein forming the elongated cover comprises a machining process.

10. The method of claim 9, wherein the machining process comprises milling or planing.

11. The method of claim 1, wherein the inner portion of the opened channel has a profile including substantially half of a desired profile of the embedded channel.

12. The method of claim 11, wherein the elongated cover includes a recess in the base of the elongated cover, the recess having a profile of other half of the desired profile of the embedded channel.

13. The method of claim 12, wherein placing the elongated cover over the opened channel comprises aligning the other half of the desired profile of the embedded channel in the elongated cover to the substantially half of the desired profile of the embedded channel in the opened channel to form the desired profile of the embedded channel.

14. The method of claim 1, wherein placing the elongated cover over the opened channel comprises clamping the elongated cover to the elongated body.

15. The method of claim 1, wherein the opened channel includes a step portion at a transition from the outer portion of the opened channel to the inner portion of the opened channel.

16. The method of claim 15, wherein the step portion comprises a shoulder.

17. The method of claim 1, further comprising surface finishing the completed elongated body having the embedded channel.

18. The method of claim 5, wherein the laser aided additive manufacturing process uses powder feeding.

19. An elongated body formed by a method of forming the elongated body with an embedded channel extending longitudinally beneath a surface along a length of the elongated body, a method comprising:
forming the elongated body with an opened channel recessed into the elongated body and with the opened channel extending longitudinally along the length of the elongated body, the opened channel having an inner portion proximal to a channel bottom of the opened channel and an outer portion distal from the channel bottom of the opened channel;
placing an elongated cover over the opened channel, the elongated cover having a base and two slope surfaces extending from the base toward an apex opposite the base wherein a distance apart between the two slope surfaces at the apex is smaller than a distance apart between the two slope surfaces at the base, to cover the inner portion of the opened channel with the base of the elongated cover to form the embedded channel, and to form two grooves, each groove having a profile defined by a corresponding slope surface of the elongated cover and defined by a corresponding outer portion of the opened channel; and
filling the two grooves to loin the elongated cover to the elongated body.
